(19) United States
(12) Patent Application Publication
(10) Pub. No.: US 2012/0087855 A1
(43) Pub. Date: Apr. 12, 2012

(54) PROCESS FOR THE OXIDATION OF HYDROGEN CHLORIDE OVER A CATALYST HAVING A LOW SURFACE ROUGHNESS

(75) Inventors: Guido Henze, Buerstadt (DE); Heiko Urtel, Bobenheim-Roxheim (DE); Martin Sesing, Waldsee (DE); Martin Karches, Neustadt (DE); Peter Van den Abeel, Brasschaat (BE); Kai Thiele, Antwerpen (BE)

(73) Assignee: BASF SE, Ludwigshafen (DE)

(21) Appl. No.: 13/377,232

(22) PCT Filed: Jun. 4, 2010
(86) PCT No.: PCT/EP2010/057814

§ 371 Date: Dec. 9, 2011

(30) Foreign Application Priority Data
Jun. 10, 2009 (EP) 09162365.2

(51) Int. Cl. C01B 7/04

(52) U.S. Cl. 423/502

(57) ABSTRACT

The invention relates to a process for the catalytic oxidation of hydrogen chloride by means of oxygen to form chlorine in a fluidized-bed process in the presence of a catalyst comprising ruthenium on a particulate support composed of alpha-aluminum oxide having an average particle size of from 10 to 200 μm, wherein the catalyst support has a low surface roughness and can be obtained from a used catalyst which has been used in a fluidized-bed process for at least 500 hours of operation.

The invention relates to a process for the catalytic oxidation of hydrogen chloride over a catalyst comprising ruthenium on a particulate support having a low surface roughness.

In the process of catalytic oxidation of hydrogen chloride developed by Deacon in 1868, hydrogen chloride is oxidized to chlorine by means of oxygen in an exothermic equilibrium reaction. Conversion of hydrogen chloride into chlorine enables chlorine production to be decoupled from sodium hydroxide production by chloralkali electrolysis. Such decoupling is attractive since the world demand for chlorine is increasing faster than the demand for sodium hydroxide. In addition, hydrogen chloride is obtained in large amounts as coproduct, for example in phosgenation reactions, for instance in isocyanate production.

EP-A 0 743 277 discloses a process for preparing chlorine by catalytic oxidation of hydrogen chloride, in which a ruthenium-comprising supported catalyst is used. Here, ruthenium is applied in the form of ruthenium chloride, ruthenium oxychlorides, chlororuthenate complexes, ruthenium hydroxide, ruthenium-amine complexes or in the form of further ruthenium complexes to the support. The catalyst can comprise palladium, copper, chromium, vanadium, manganese, alkali metals, alkaline earth metals and rare earth metals as further metals.

According to GB 1,046,313, ruthenium(III) chloride on aluminum oxide is used as catalyst in a process for the catalytic oxidation of hydrogen chloride.

DE 10 2005 040286 A1 discloses a mechanically stable catalyst for the oxidation of hydrogen chloride, which comprises, on alpha-aluminum oxide as support,
a) from 0.001 to 10% by weight of ruthenium, copper and/or gold,
b) from 0 to 5% by weight of one or more alkaline earth metals,
c) from 0 to 5% by weight of one or more alkaline metals,
d) from 0 to 10% by weight of one or more rare earth metals,
e) from 0 to 10% by weight of one or more further metals selected from the group consisting of palladium, platinum, osmium, iridium, silver and rhenium.

As promoters suitable for doping, mention is made of alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof, also titanium, manganese, molybdenum and tin.

A fluidized-bed catalyst which is operated in a reactor made of nickel-comprising steels (e.g. HC4, Inconel 600, etc.) produces NiCl₂ during the Deacon reaction due to corrosion and erosion of the reactor. Continuing erosion shortens the life of the fluidized-bed reactor.

It is an object of the present invention to remedy the above-described disadvantages.

The object is achieved by a process for the catalytic oxidation of hydrogen chloride by means of oxygen to form chlorine in a fluidized-bed process in the presence of a catalyst comprising ruthenium on a particulate support composed of alpha-aluminum oxide having an average particle size of from 10 to 200 μm, wherein the catalyst support has a low surface roughness and can be obtained from a used catalyst which has been used in a fluidized-bed process for at least 500 hours of operation.

It has been found that a fluidized-bed catalyst based on alpha-aluminum oxide support particles which have been recovered from a used fluidized-bed catalyst results in significantly reduced removal of material at the wall of the fluidized-bed reactor when the used fluidized-bed catalyst has been used beforehand for at least 500 hours of operation in a fluidized-bed process. The used fluidized-bed catalyst has preferably been used for at least 1000 hours of operation in a fluidized-bed process.

The catalyst support preferably has an average diameter (d₅₀) of preferably from 30 to 100, particularly preferably from 40 to 80.

In general, the fluidized-bed reactors used in the process of the invention are reactors made of a nickel-comprising material. The nickel content is preferably at least 10% by weight. In addition, the nickel-comprising materials can comprise one or more further metals as alloying constituents, for example metals selected from among iron, molybdenum, chromium and titanium. Examples of nickel-comprising materials are HC4 (2.4810 NiCr15Fe) and Inconel 600 (NiMo16Cr16Ti).

The fluidized bed is operated at a gas velocity which is generally from 3 to 500 times, preferably from 10 to 200 times, particularly preferably from 30 to 100 times, the gas velocity at the fluidization point (i.e. at the commencement of fluidization).

The pulverulent catalyst support used according to the invention is preferably obtained from used ruthenium-comprising catalysts which comprise alpha-aluminum oxide as support, if appropriate in admixture with further support materials, and have been used beforehand in the Deacon process. In general, the support consists essentially of alpha-aluminum oxide but can comprise further support materials, for example graphite, silicon dioxide, titanium dioxide and/or zirconium dioxide, preferably titanium dioxide and/or zirconium dioxide.

The support used according to the invention can be obtained from a used catalyst comprising ruthenium oxide by
a) reducing the catalyst comprising ruthenium oxide in a gas stream comprising hydrogen chloride and, if appropriate, an inert gas at a temperature of from 300 to 500° C.;
b) treating the reduced catalyst from step a) with hydrochloric acid in the presence of an oxygen-comprising gas, with the metallic ruthenium present on the support being dissolved as ruthenium chloride and being separated off as aqueous ruthenium chloride solution,
   or
a) reducing the catalyst comprising ruthenium oxide in a gas stream comprising hydrogen and, if appropriate, an inert gas at a temperature of from 150 to 600° C.;
b) treating the reduced catalyst from step a) with hydrochloric acid in the presence of an oxygen-comprising gas, with the metallic ruthenium present on the support being dissolved as ruthenium chloride and being separated off as aqueous ruthenium chloride solution.

The ruthenium chloride solution can, if appropriate after being concentrated, be used for producing a fresh catalyst.

The catalysts used according to the invention are obtained by impregnating the used support material with aqueous solutions of salts of the metals. The metals are usually applied as aqueous solutions of their chlorides, oxychlorides or oxides to the support.

The specific surface area of the alpha-aluminum oxide support before deposition of metal salts is generally in the range from 0.1 to 10 m²/g. alpha-Aluminum oxide can be prepared by heating gamma-aluminum oxide to temperatures above 1000° C. and is preferably prepared in this way. In general, it is calcined for from 2 to 24 hours.

The catalyst used according to the invention can comprise, in addition to ruthenium, further metals as promoters. These are usually comprised in the catalyst in amounts of up to 10% by weight, based on the weight of the catalyst.

In a preferred embodiment, the catalyst used according to the invention comprises nickel in addition to ruthenium. It has been found that a nickel-doped ruthenium-comprising catalyst has a higher activity than a catalyst without nickel. It is presumed that this activity increase is attributable both to the promoting properties of nickel chloride and to the better dispersion of the active component on the surface of the catalyst brought about by the nickel chloride. Thus, ruthenium is present on the catalyst according to the invention in fresh or regenerated form as RuO₂ crystallites having a crystallite size of <7 nm. The crystallite size is determined as the width at half height of the reflection of the species in the XRD measurement.

The ruthenium-comprising catalysts for the catalytic oxidation of hydrogen chloride can additionally comprise compounds of one or more further noble metals selected from among palladium, platinum, iridium and silver. The catalysts can further comprise rhenium. The catalysts can also be doped with one or more further metals. Metals suitable as promoters for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium, rare earth metals such as scandium, yttrium, lanthanum, cerium, praseodymium and neodymium, preferably scandium, ytrrium, lanthanum and cerium, particularly preferably lanthanum and cerium, or mixtures thereof, also titanium.

Catalysts preferred for the oxidation of hydrogen chloride comprise
a) from 0.1 to 10% by weight of ruthenium,
b) from 0 to 10% by weight of nickel,
c) from 0 to 5% by weight of one or more alkaline earth metals,
d) from 0 to 5% by weight of one or more alkali metals,
e) from 0 to 5% by weight of one or more rare earth metals,
f) from 0 to 5% by weight of one or more further metals selected from the group consisting of palladium, platinum, iridium, silver and rhenium,
   in each case based on the total weight of the catalyst. The percentages by weight are based on the weight of the metal even though the metals are generally present in oxidic or chloridic form on the support.

In general, the total content of further metals c) to f) present in addition to ruthenium and, if appropriate, nickel is not more than 5% by weight.

The catalyst used according to the invention very particularly preferably comprises from 0.5 to 5% by weight of ruthenium and from 0.5 to 5% by weight of nickel, based on the weight of the catalyst. In a specific embodiment, the catalyst used according to the invention comprises from about 1 to 3% by weight of ruthenium and from 1 to 3.5% by weight of nickel on alpha-aluminum oxide as support and no further active metals or promoter metals, with ruthenium being present as RuO₂.

The supported ruthenium catalysts can be obtained, for example, by impregnating the support material with aqueous solutions of RuCl₃ and, if appropriate, NiCl₂ and also the further promoters for doping, preferably in the form of their chlorides. The powders can subsequently be dried and if appropriate calcined at temperatures of from 100 to 500° C., preferably from 100 to 300° C., for example under a nitrogen, argon or air atmosphere. The powders are preferably firstly dried at from 100 to 150° C. and subsequently calcined at from 200 to 500° C.

After deactivation of the catalyst, the support can be recovered and reused for producing a supported ruthenium catalyst.

To carry out the oxidation of hydrogen chloride, a stream of hydrogen chloride and an oxygen-comprising stream are fed into the fluidized-bed reactor and hydrogen chloride is partly oxidized to chlorine in the presence of the catalyst, giving a product gas stream comprising chlorine, unreacted oxygen, unreacted hydrogen chloride and water vapor. The stream of hydrogen chloride, which can originate from a plant for preparing isocyanates, can comprise impurities such as phosgene and carbon monoxide.

Customary reaction temperatures are in the range from 150 to 500° C. and customary reaction pressures are in the range from 1 to 25 bar, for example 4 bar. The reaction temperature is preferably >300° C. and is particularly preferably in the range from 350° C. to 420° C. It is also advantageous to use oxygen in superstoichiometric amounts. It is customary to use, for example, a 1.5- to four-fold excess of oxygen. Since no decreases in selectivity have to be feared, it can be economically advantageous to work at relatively high pressures and accordingly at residence times which are longer than at atmospheric pressure.

The fluidized catalyst bed can comprise inert material in addition to the catalyst, preferably in the form of additional, inactive support material. The inactive inert material is likewise used catalyst material which owing to use in a fluidized-bed process over a period of at least 500 hours of operation has a low surface roughness. Inert material can be used in amounts of from 0 to 90% by weight, preferably from 10 to 50% by weight, based on the sum of catalyst and inert material.

The conversion of hydrogen chloride in a single pass can be limited to from 15 to 90%, preferably from 40 to 85%. Unreacted hydrogen chloride can, after having been separated off, be recirculated in part or in its entirety to the catalytic oxidation of hydrogen chloride. The volume ratio of hydrogen chloride to oxygen at the reactor inlet is generally in the range from 1:1 to 20:1, preferably from 1.5:1 to 8:1, particularly preferably from 1.5:1 to 5:1.

The chlorine formed can subsequently be separated off in the usual way from the product gas stream obtained in the catalytic oxidation of hydrogen chloride. The separation usually comprises a plurality of stages, namely the separation of unreacted hydrogen chloride from the product gas stream from the catalytic oxidation of hydrogen chloride and if appropriate recirculation of this hydrogen chloride, drying of the residual gas stream obtained, which consists essentially of chlorine and oxygen, and the separation of chlorine from the dried stream.

A ruthenium-comprising hydrogen chloride oxidation catalyst used according to the invention can also be obtained by regenerating a used fluidized-bed catalyst which has been used for at least 500 hours of operation in a hydrogen chloride oxidation process. This can be regenerated by, for example:
a) reducing the catalyst in a gas stream comprising hydrogen chloride and if appropriate an inert gas at a temperature of from 300 to 500° C.,
b) recalcining the catalyst in an oxygen-comprising gas stream at a temperature of from 200 to 450° C.

It has been found that RuO₂ can be reduced by means of hydrogen chloride. It is assumed that the reduction occurs via RuCl₃ to elemental ruthenium. Thus, if a partially deactivated catalyst comprising ruthenium oxide is treated with hydrogen chloride, ruthenium oxide is presumably reduced quantitatively to ruthenium after a sufficiently long treatment time. As a result of this reduction, the RuO₂ crystallites are destroyed and the ruthenium, which can be present as elemental ruthenium, as a mixture of ruthenium chloride and elemental ruthenium or as ruthenium chloride, is redispersed on the support. After the reduction, the ruthenium can be reoxidized to the catalytically active RuO₂ by means of an oxygen-comprising gas, for example air. It has been found that the catalyst obtained in this way once again has approximately the activity of the fresh catalyst. An advantage of the process is that the catalyst can be regenerated in situ in the reactor and does not have to be removed from the reactor.

The regenerated catalyst has a low surface roughness corresponding to the period of operation.

The invention is illustrated by the following examples.

### EXAMPLES

### Example 1

The fresh catalyst is produced by impregnation of the support (α-Al₂O₃ powder, d₅₀=50 μm) with an aqueous RuCl₃ solution, drying and calcination at from 300 to 450° C. for from 0.5 to 5.0 hours. The fresh catalyst has a very rough surface and therefore produces high abrasion of the reactor in a fluidized-bed process.

600 g of the catalyst are operated at 400° C. using 200 standard l·h⁻¹ of HCl and 100 standard l·h⁻¹ of O₂ in a fluidized-bed reactor having a diameter of 44 mm, a height of 990 mm and a bed height of from 300 to 350 mm. The catalyst is present in the form of a powder having an average diameter of 50 microns (d₅₀). A hydrogen chloride conversion of 61% is obtained. The catalyst is operated at from 360 to 380° C.

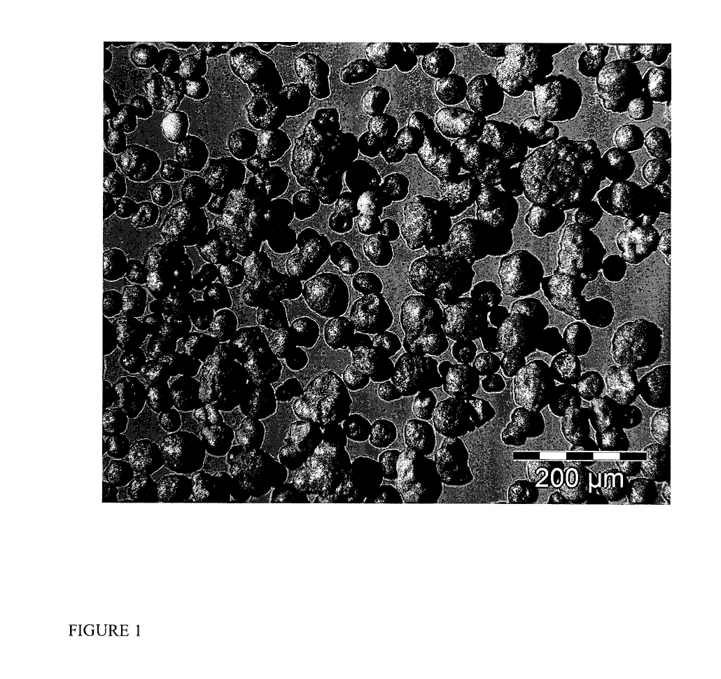

FIG. 1 shows a photograph of the fresh catalyst.

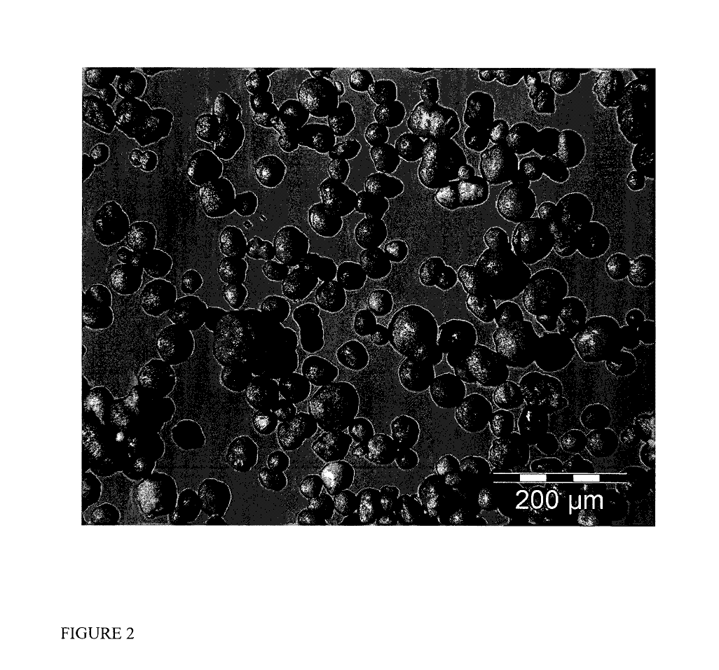

FIG. 2 shows a photograph of the catalyst after 675 hours of operation.

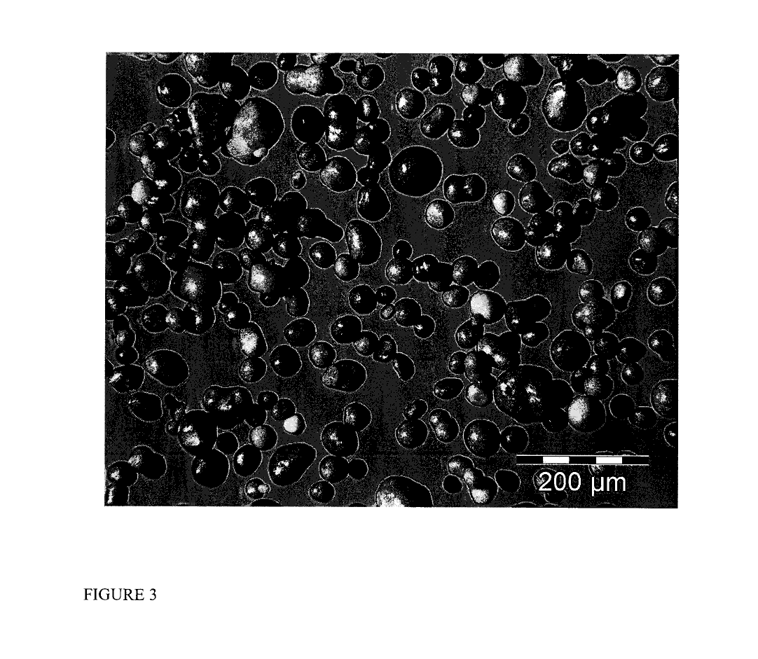

FIG. 3 shows a photograph of the catalyst after 7175 hours of operation.

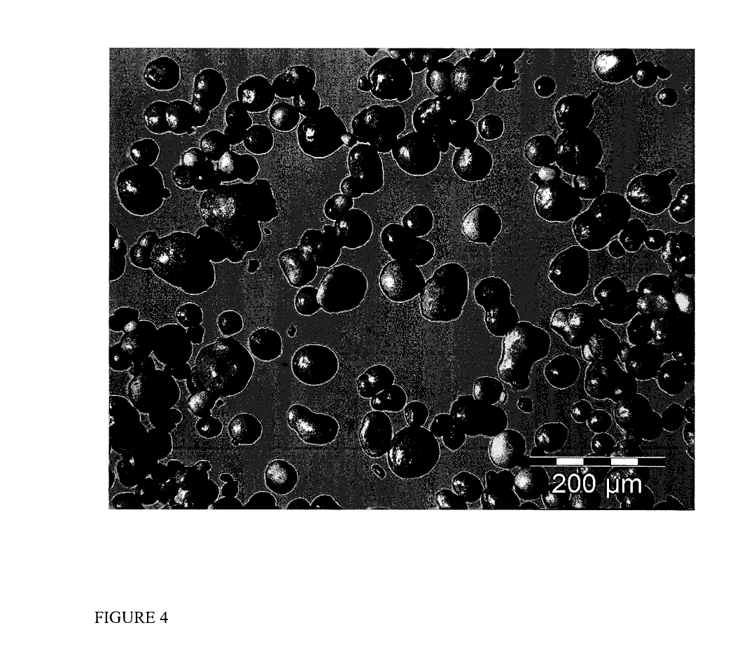

FIG. 4 shows a photograph of the catalyst after 9485 hours of operation.

The fresh catalyst displays a rough surface and as a result brings about an average erosion rate of the reactor wall of 0.30 mm/year. After 675 hours, slight rounding of the catalyst surface can be seen, which is reflected in a slightly reduced erosion rate of 0.28 mm/year. After 7175 hours, the catalyst is rounded to such an extent that the erosion rate decreases to 0.04 mm/year. Finally, after 9485 hours, the erosion rate is virtually zero because of the smooth catalyst surface.

Recycling of the support makes it possible to prepare a fresh catalyst which causes virtually no erosion of the reactor wall from the beginning and thus greatly increases the life of the reactor.

### Example 2

585 g of a used and deactivated fluidized-bed catalyst comprising 2% by weight of RuO₂ on alpha-Al₂O₃ (average diameter (d₅₀): 50 μm) and, as a consequence of corrosion and erosion of the nickel-comprising reactor, 2.5% by weight of nickel chloride is treated with 100 standard l/h of gaseous HCl at 430° C. in the fluidized-bed reactor described in example 1 for 70 hours. The reduced catalyst obtained in this way is treated with 2000 ml of a 20% strength HCl solution at 100° C. with vigorous stirring for 96 hours in a 2500 ml glass reactor. 20 standard l/h of air are bubbled in during the entire treatment time. The supernatant Ru- and Ni-comprising solution is separated from the solid (support) by filtration and the filter cake is washed with 500 ml of water. The combined aqueous phases comprise >98% of the ruthenium and of the nickel. Evaporation of part of this solution to 18 ml gives a solution comprising 4.2% by weight of ruthenium and 7.0% by weight of nickel.

### Example 3

200 g of a deactivated fluidized-bed catalyst obtained after 9485 hours of operation in the fluidized-bed reactor described in example 1 are subjected to the recycling process described in example 2 in order to recover the support. 50 g of the rounded support obtained in this way are impregnated with 18 ml of an aqueous RuCl₃ solution (Ru content=4.2% by weight) by the spray process in a rotating glass flask and the resulting solid is dried at 120° C. for 16 hours. The dried material is calcined at 380° C. in air for 1 hour. The RuO₂-comprising catalyst formed in this way can be reused for the catalytic oxidation of HCl by means of O₂.

2 g of this catalyst are mixed with 118 g of α-Al₂O₃ and 9.0 standard l/h of HCl and 4.5 standard l/h of O₂ are passed through the mixture from below via a glass frit at 360° C. in a fluidized-bed reactor (d=29 mm; height of the fluidized bed: 20-25 cm) and the HCl conversion is determined by passing the resulting gas stream into a potassium iodide solution and subsequently titrating the iodine formed with a sodium thiosulfate solution. An HCl conversion of 37.7% is found.

### Example 4

21 kg of the used catalyst from example 2 (RuO₂ on α-Al₂O₃ comprising 2.5% by weight of nickel chloride) are operated using 10.5 kg·h·⁻¹ of HCl, 4.6 kg·h⁻¹ of O₂ and 0.9 kg·h⁻¹ of N₂ at 400° C. in a fluidized-bed reactor having a diameter of 108 mm, a height of 4-4.5 m and bed-height of 2.5-3 m. The catalyst is present in the form of a powder having an average diameter of 50 microns (d₅₀). A conversion of HCl of 77% is obtained. The oxygen is then switched off for 20 hours at 400° C. and replaced by 10.0 kg·h⁻¹ of HCl. After 20 hours, the catalyst is recalcined and thus reactivated at 400° C. under 2.0 kg·h⁻¹ of O₂ and 8.0 kg·h⁻¹ of N₂ for 30 minutes. After this treatment, the catalyst displays an HCl conversion of 84% at 400° C. using 10.5 kg·h⁻¹ of HCl, 4.6 kg·h⁻¹ of O₂ and 0.9 kg·h⁻¹ of N₂.

1. A process for the catalytic oxidation of hydrogen chloride, the process comprising reacting hydrogen chloride and oxygen to obtain chlorine in a fluidized-bed reactor in the presence of a catalyst comprising ruthenium on a particulate support, the particulate support comprising alpha-aluminum oxide having an average particle size of 10 to 200 μm, wherein the catalyst has a low surface roughness, and wherein the catalyst is optionally obtained from a used catalyst which has been used in a fluidized-bed reactor for at least 500 hours of operation.

2. The process of claim 1, wherein the particulate support consists essentially of alpha-aluminum oxide.

3. The process of claim 1, wherein the catalyst comprises
a) 0.1 to 10% by weight of ruthenium,
b) 0 to 10% by weight of nickel,
c) 0 to 5% by weight of an alkaline earth metal,
d) 0 to 5% by weight of an alkali metal,
e) 0 to 5% by weight of a rare earth metal,
f) 0 to 5% by weight of at least one further metal selected from the group consisting of palladium, platinum, iridium, silver and rhenium,
in each case based on the total weight of the catalyst.

4. The process of claim 1, wherein the catalyst is obtained from a used catalyst comprising ruthenium oxide by
a) reducing the used catalyst in a gas stream comprising hydrogen chloride and optionally an inert gas, at a temperature of 300 to 500° C., or
reducing the used catalyst in a gas stream comprising hydrogen and optionally an inert gas, at a temperature of 150 to 600° C., to obtain a reduced catalyst, and
b) treating the reduced catalyst a) with hydrochloric acid in the presence of a gas comprising oxygen, to effect a dissolving of metallic ruthenium present on the particulate support as ruthenium chloride, and to effect a separating of the ruthenium chloride as an aqueous ruthenium chloride solution.

5. The process of claim 1, wherein the catalyst is obtained by impregnating the particulate support with
i) at least one metal salt solution comprising ruthenium, and
ii) optionally at least one further promoter metal and
drying and calcining the impregnated support.

6. The process of claim 1, wherein the particulate support has an average particle size of 30 to 100 μm.

7. The process of claim 1, wherein the particulate support has an average particle size of 40 to 80 μm.

8. The process of claim 1, wherein the catalyst is obtained from a used catalyst which has been used in a fluidized-bed reactor for at least 500 hours of operation.

9. The process of claim 1, wherein the catalyst is obtained from a used catalyst which has been used in a fluidized-bed reactor for at least 1000 hours of operation.

10. The process of claim 1, wherein the particulate support further comprises at least one selected from the group consisting of graphite, silicon dioxide, titanium dioxide, and zirconium dioxide.

11. The process of claim 1, wherein the particulate support has a specific surface area of 0.1 to 10 m²/g.

12. The process of claim 1, wherein the catalyst further comprises nickel.

13. The process of claim 3, wherein a sum of b), c), d), e) and f) is not more than 5% by weight, based on the total weight of the catalyst.

14. The process of claim 3, wherein the catalyst comprises 0.5 to 5% by weight of ruthenium, and 0.5 to 5% by weight of nickel, based on the total weight of the catalyst.

15. The process of claim 3, wherein the catalyst comprises 1 to 3% by weight of ruthenium, and 1 to 3.5% by weight of nickel, based on the total weight of the catalyst.

16. The process of claim 1, wherein the fluidized-bed reactor comprises at least 10% by weight of nickel, based on the total weight of the reactor.

17. The process of claim 16, wherein the fluidized-bed reactor further comprises at least one selected from the group consisting of iron, molybdenum, chromium, and titanium.

18. The process of claim 1, wherein the alpha-aluminum oxide is obtained by heating gamma-aluminum oxide to a temperature above 1000° C.

19. The process of claim 1, wherein the ruthenium comprises RuO₂ crystallites having a size less than 7 nm.

20. The process of claim 5, wherein the catalyst is obtained by impregnating the particulate support with
i) at least one metal salt solution comprising ruthenium, and
ii) at least one further promoter metal, and
drying and calcining the impregnated support.
